(19) United States
(12) Patent Application Publication
(10) Pub. No.: US 2004/0256051 A1
(43) Pub. Date: Dec. 23, 2004

(54) Method of manufacturing container covers

(76) Inventors: Robert R. Turvey, Sandord, MI (US); John O. McCree, Bay City, MI (US)

Correspondence Address: S.C. JOHNSON & SON, INC., 1525 HOWE STREET, RACINE, WI, 53403-2236, US

(21) Appl. No.: 10/865,026

(22) Filed: Jun. 10, 2004

Related U.S. Application Data
(60) Provisional application No. 60/478,479, filed on Jun. 13, 2003.

(51) Int. Cl. B29C 53/36; B29C 65/00; B29B 17/00; B32B 31/08; B32B 31/18

(52) U.S. Cl. 156/204; 156/244.18; 156/244.19; 156/500; 156/513; 156/459; 156/461; 156/200; 156/252; 156/267; 156/269; 156/514; 156/516

(57) ABSTRACT

Disposable polymeric container covers, methods of manufacturing the same, and machines for manufacturing the same are disclosed wherein the cover may include a polymer film adapted to enclose a bowl or the like, and an elastic film proximate thereto adapted to seal the cover against the bowl. The elastic film may be provided as an annular member completely surrounding the bowl, or in segments around an otherwise non-elastic ring. The method may include co-extruding the elastic with the non-elastic polymer, or stamping the elastic and non-elastic polymers as separate pieces and then heat sealing them together.

### CROSS REFERENCE TO RELATED APPLICATION

This application is related to, and claims the priority benefit of, U.S. Provisional Patent Application No. 60/478,479, filed Jun. 13, 2003.

### FIELD OF THE DISCLOSURE

The disclosure generally relates to polymeric container covers, methods of manufacturing the same, and machines for manufacturing the same.

### BACKGROUND OF THE DISCLOSURE

Disposable container covers capable of covering containers of various sizes and shapes have been in use for many years. Such covers typically include a plastic film, such as polyethylene, provided in sufficient dimension to overlay the container opening. The film then employs surface tension or elastic bands to secure the film to the container, such as with Saran® wrap or Quick Covers®, respectively, both being products of the present assignee, with the latter having an elastic band sewn directly to the film around its perimeter. The elastic band bordering the film is attached in such a manner that tension is created on the film, thereby creating a hollow enclosure with an expandable opening for placing atop and around containers of various sizes and shapes.

Use of such container covers is common for both perishable and nonperishable items. While these covers are beneficial in many respects, they are not without room for improvement. A common problem with existing container covers is the lack of an effective seal between the cover and the container. This is especially problematic with regard to food storage. First, depending on the size of the container cover relative to the container, the conventional container covers described above are vulnerable to slippage and inadvertent removal from the container. Any attempt at preserving freshness or protecting the contents of the container from exposure to various elements is futile where the container cover does not actually cover the container, but instead, slips off the container.

Even when such conventional covers remain appropriately positioned on a container, their sealing capabilities are limited. More specifically, given the limited constriction afforded by elastic bands, the susceptibility of films to lose surface tension, and/or the irregular shapes of the containers being sealed, air and moisture can flow relatively freely in and out of containers covered with conventional container covers. Consequently, where a substantial or hermetic seal is desired, as opposed to where air or moisture ventilation is desired, the goal of preserving the freshness of perishable items is less likely to be realized with conventional disposable covers.

An additional problem with conventional container covers relates to manufacturing. Specifically, conventional container covers, as described above, require the slow, labor intensive manufacturing step of manually sewing an elastic band to the periphery of the film. These covers do not readily lend themselves to high-speed automated manufacturing, in turn, driving up the cost and time of manufacturing conventional container covers.

### BRIEF DESCRIPTION OF THE DRAWINGS

FIG. 1a is a plan view of a container cover according to the teachings of the disclosure.

FIG. 1b is a cross-sectional view taken along line 1b-1b of the container cover shown in FIG. 1a.

FIG. 2a is a plan view of an apparatus for manufacturing container covers during a preliminary stage according to the teachings of the disclosure.

FIG. 2b is a plan view of preliminary output atop a receiving device according to the teachings of the disclosure.

FIG. 3a is a plan view of an apparatus for manufacturing container covers during a standard stage according to the teachings of the disclosure.

FIG. 3b is a plan view of standard output atop a receiving device according to the teachings of the disclosure.

FIG. 4 is a perspective view of a first phase of a standard stage of operation of an apparatus for manufacturing container covers according to the teachings of the disclosure.

FIG. 5 is a perspective view of a second phase of a standard stage of operation of an apparatus for manufacturing container covers according to the teachings of the disclosure.

FIG. 6 is a perspective view of a third phase of a standard stage of operation of an apparatus for manufacturing container covers according to the teachings of the disclosure.

FIG. 7 is a perspective view of a fourth phase of a standard stage of operation of an apparatus for manufacturing container covers according to the teachings of the disclosure.

FIG. 8a is a plan view of a container cover according to the teachings of the disclosure.

FIG. 8b is a plan view of a container cover according to the teachings of the disclosure.

FIG. 9 is a perspective view of an apparatus for manufacturing container covers according to the teachings of the disclosure.

FIG. 10a is a plan view of a first stage of production of a container cover according to the teachings of the disclosure.

FIG. 10b is a plan view of a second stage of production of a container cover according to the teachings of the disclosure.

FIG. 10c is a plan view of a third stage of production of a container cover according to the teachings of the disclosure.

FIG. 10d is a plan view of a fourth stage of production of a container cover according to the teachings of the disclosure.

FIG. 10e is a plan view of a fifth stage of production of a container cover according to the teachings of the disclosure.

FIG. 10f is a cross-sectional view of the first stage of production of a container cover as shown in FIG. 10a.

While the disclosure is susceptible to various modifications and alternative constructions, certain illustrative embodiments thereof have been shown in the drawings and will be described below in detail. It should be understood, however, that there is no intention to limit the disclosure to the specific embodiments disclosed, but on the contrary, the intention is to cover all modifications, alternative constructions, and equivalents falling within the spirit and scope of the disclosure as defined by the appended claims.

### DETAILED DESCRIPTION

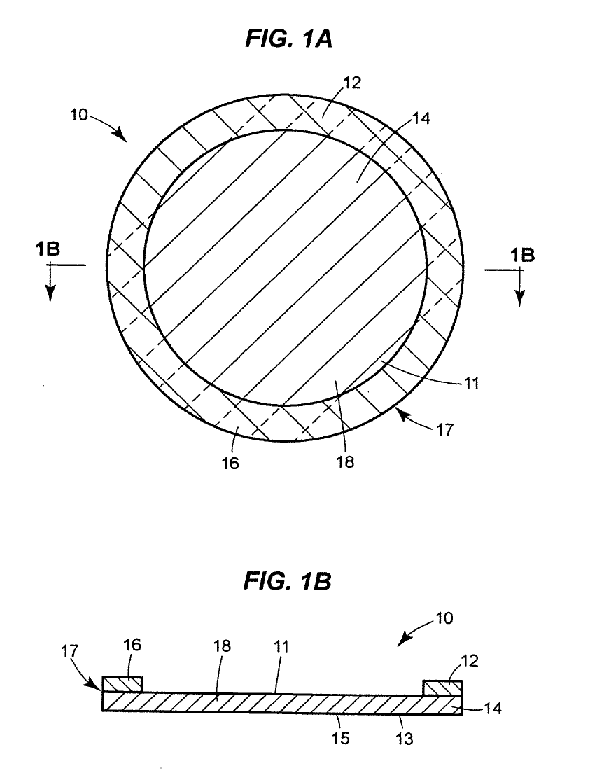

Referring now to the drawings and with specific reference to FIGS. 1a and 1b, a container cover 10 is provided comprising a first polymer 12 and a second polymer 14. A first layer 16 comprises the first polymer 12 and a second layer 18 comprises the second polymer 14, said layers operatively associated with one another at a first surface 11 of the second layer 18. In some embodiments, there may be additional layers, such as an insulating layer operatively associated with the second layer 18 at a second surface 13 of the second layer 18. Such a configuration is useful as it helps prevent the contamination of the insulating layer. The first and second layers 16, 18 are sealed about a perimeter 17. Although the container cover 10 is shown in a circular shape, that is for illustrative purposes only, as the container cover 10 may be made in any shape or size. The shape and size may be customized to fit a particular container. Custom fitting can help prevent or eliminate excessive plastic folds or gather in the container cover.

The first polymer 12 may comprise an elastomeric material, e.g. an elastic film. Compatible elastomeric materials include, but are not limited to, Tredegar Product CEX-816WR, Tredegar Product X-25132, Dow Chemical Product Affinity—Polyolefin Plastomers 8200 Series, Dow Chemical Product Affinity—Polyolefin Plastomers PF 1140 Series, Dow Chemical Product Affinity—Flexomer 9078 Series. The second polymer may comprise, but is not limited to, polyethylene (PE) or polypropylene (PP). An additional insulating layer may comprise, but is not limited to, 3M Thinsulate® or non-woven PE.

The container cover 10 may also comprise a handle that allows for lifting and/or “burping” of the container. That is, pulling such a handle allows for air to be released from the container. Such a handle may be located, for example, at a center 15 on the second surface 13, so as to be operatively associated with the cover 10. In some embodiments, the cover 10 will have one or more handles operatively associated along the perimeter 17.

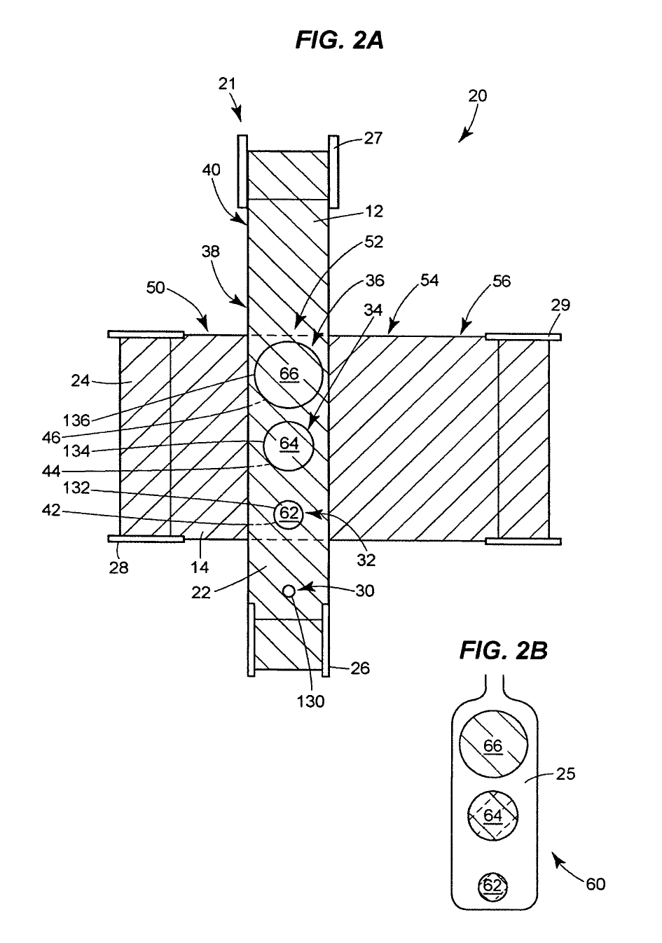

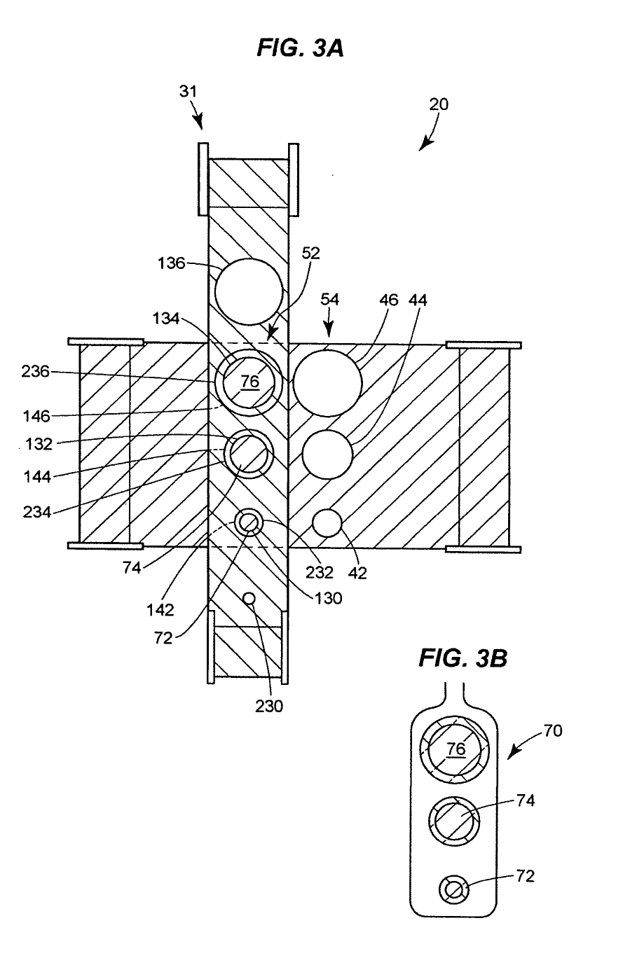

A method of manufacturing a container cover 10 using an apparatus (machine) 20 is presented in FIGS. 2a and 2b. A first web 22 comprises the first polymer 12, and a second web 24 comprises the second polymer 14. The first web 22 may be positioned above the second web 24. Although the positioning of said webs is shown as transverse and perpendicular in FIGS. 2a and 3a, the webs may take on a range of relative positions, and in some embodiments may be parallel. The first web 22 may be spooled from a first supply roll 26 to a first receiving roll 27. The second web 24 may be spooled from a second supply roll 28 to a second receiving roll 29. The first web 22 may be advanced towards the first receiving roll 27, and the second web 24 may be advanced towards the second receiving roll 29. The first and second webs 22, 24 are superimposed at position 52. A receiving device 25 may be placed beneath the second web 24 at position 52 to receive container covers, e.g. 10, after they have been sealed and cut from the first and second webs 22, 24. In some embodiments, the receiving device 25 comprises a vacuum arm that may receive container covers, from which they are delivered for packaging.

FIG. 2a illustrates by use of references numbers 32, 34, 36, 38, 40, 50, 52, 54 and 56 positions in a plane of the apparatus 20. Said positions help describe the positions that the first and second webs 22, 24 and components thereof may occupy.

FIG. 2a illustrates a preliminary stage 21 of the manufacturing process, which generates preliminary output 60 shown in FIG. 2b. The preliminary stage does not generate the container cover 10, but rather the scrap covers 62, 64 and 66 of the preliminary output 60, which may be recycled. In the preliminary stage 21, a first pilot hole 130 is at position 30. Such pilot holes may be punched out at this position or formed at an earlier stage. The apparatus 20 at position 32 generates a small hole in the first web, e.g. 132, a small hole in the second web 42, and a scrap small cover, e.g. 62. The apparatus 20 at position 34 generates a medium hole in the first web, e.g. 134, a medium hole in the second web, e.g. 44, and a medium scrap cover, e.g. 64. The apparatus at position 36 generates a large hole in the first web, e.g. 136, a large hole in the second web, e.g. 46, and a large scrap cover, e.g. 66.

FIGS. 3a and 3b represent a standard stage 31 of the apparatus 20, which generates a container cover, e.g. 10, in three different sizes as illustrated by the covers 72, 74 and 76 of the standard output 70. In FIG. 3a, the first web 22 and the second web 24 have each advanced one position. A second pilot hole 230 is now in position 30. The first pilot hole 130 occupies position 32, the small hole 132 occupies position 34, the medium hole 134 occupies position 36, and the large hole 136 occupies position 38. The small hole 42, medium hole 44 and large hole 46 of the second web 22 occupy position 54. The apparatus 20 at position 32 generates a small hole in the first web, e.g. 232, a small hole in the second web 142, and a small cover, e.g. 72. The apparatus 20 at position 34 generates a medium hole in the first web, e.g. 234, a small hole in the second web, e.g. 144, and a medium cover, e.g. 74. The apparatus at position 36 generates a large hole in the first web, e.g. 236, a large hole in the second web, e.g. 146, and a large cover, e.g. 76.

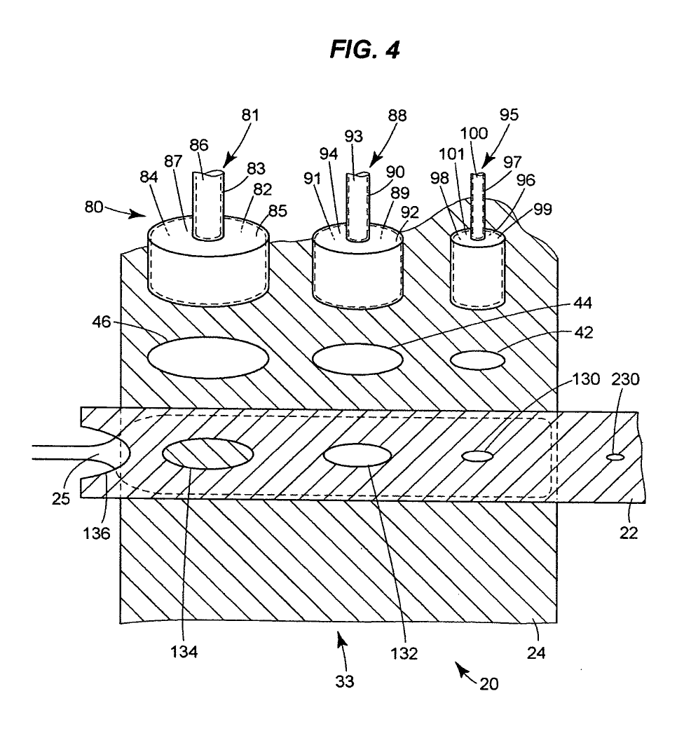

FIGS. 4-7 illustrate four phases, 33, 35, 37 and 39 respectively, of the standard stage 31 of the manufacturing process. In FIG. 4, the first web 22 and second web 24 have advanced from their respective positions they had occupied in the preliminary stage 21, but the container covers 72, 74 and 76 have not yet been produced. An output generator 80 may comprise three stamping modules: a large generator module 81, a medium generator module 88 and a small generator module 95. While three generator modules are illustrated, there is no limit to the number of modules in a given stamping apparatus 80. Each generator module, e.g. 81, 88 and 95, may comprise a sealing device, e.g. 82, 89 and 96, and a stamping device, e.g. 85, 92 and 99. Each sealing device may comprise a sealing shaft, e.g. 83, 90 and 97, and a sealing head, e.g. 84, 91 and 98. Each stamping device may comprise a stamping shaft, e.g. 86, 93 and 100, and a stamping head, e.g. 87, 94 and 101. Each sealing device may be housed within the respective stamping device. The output generator 80, modules 81, 88 and 95, sealing devices 82, 89 and 96, stamping devices 85, 92 and 99, and other components of the output generator 80 may all take on a number of different forms, positions, shapes, sizes, etc., and those shown are for illustrative purposes only. In the first phase 33, both the sealing devices and the stamping devices are in their retracted positions.

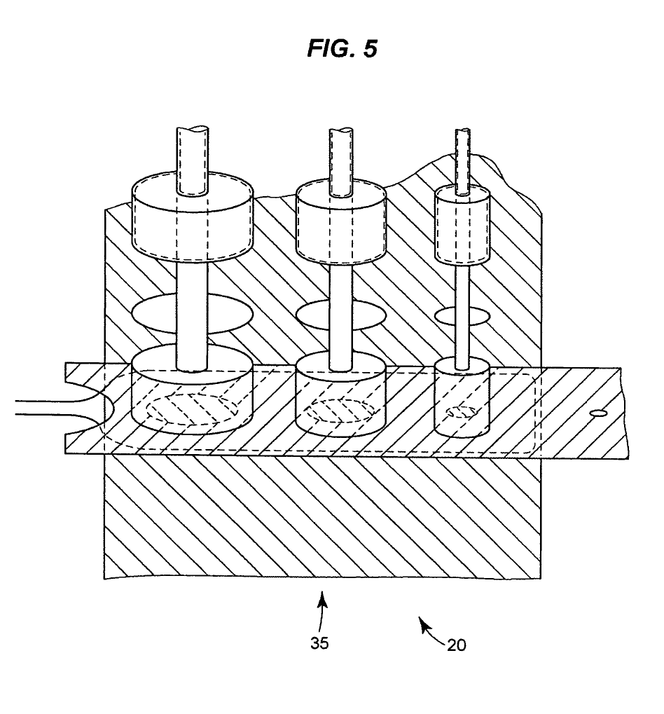

FIG. 5 illustrates a second phase 35 of the standard stage 31, in which the three sealing devices 82, 89 and 96 have dropped and made contact with the first web 22, which in turn is in contact with the second web 24. The stamping devices 85, 92 and 99 remain in the retracted position. The sealing devices serve to seal the first and second webs 22, 24 together at respective positions 32, 34 and 36. This sealing may be accomplished by any number of processes. In one embodiment the webs are sealed together using heat. The sealing devices are in contact with the first and/or second web for a sufficient dwell time to allow the webs to fuse.

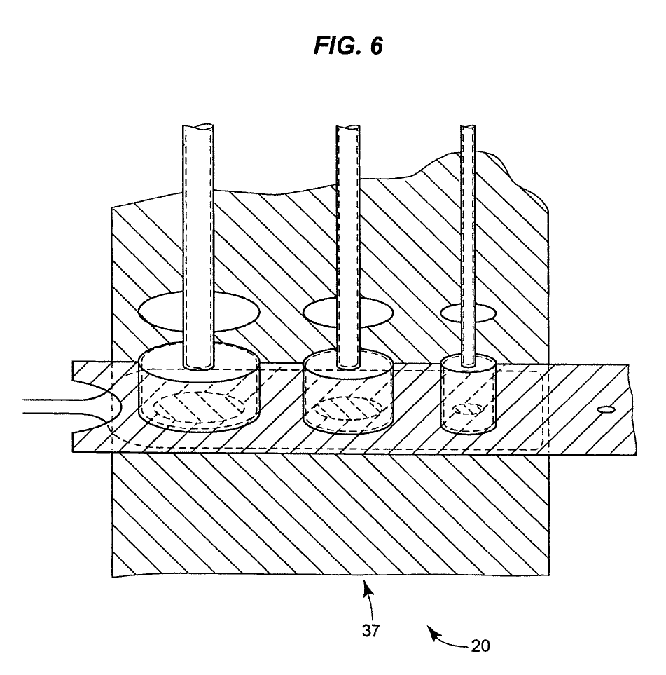

FIG. 6 illustrates a third phase 37 of the standard stage 31, in which both the sealing devices 82, 89, and 96, and the stamping devices 85, 92 and 99 have dropped and have become associated with the first and second webs 22, 24. The stamping devices serve to cut out the container covers 72, 74 and 76 from their respective positions 32, 34 and 36. The container covers may be cut out by any number of processes including hot wire, hot knife, razor blades, laser, ultrasound, molten plastic, etc.

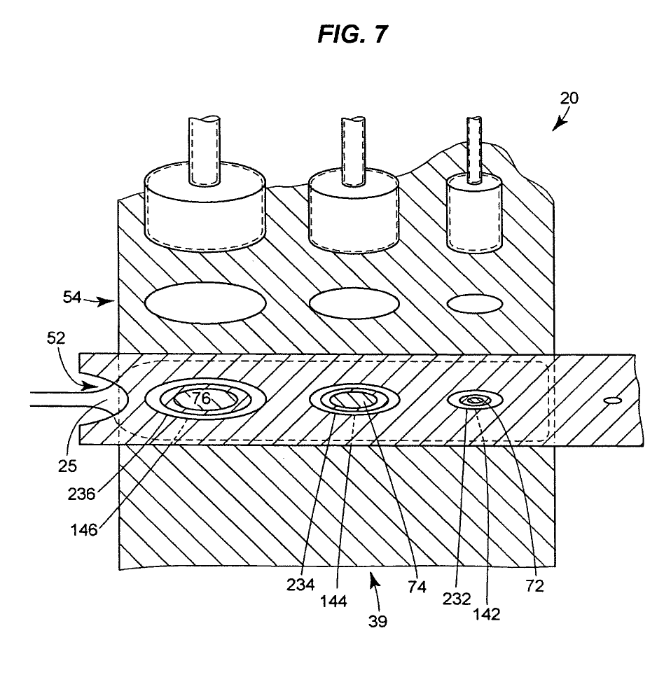

FIG. 7 illustrates a fourth phase 39 of the standard stage 31. Both the sealing devices 82, 89, and 96, and the stamping devices 85, 92 and 99 have again retracted. The container covers 72, 74 and 76 have been received by the receiving device 25. The fourth phase 39 of the standard stage 31 illustrated in FIG. 7 corresponds to the planar views shown in FIGS. 3a and 3b. Following the fourth phase 39 shown in FIG. 7, the first web 22 and the second web 24 may both move one position to arrive at a relative position in respect to position 52 so that the first phase 33 of the standard stage 31 repeated and the cycled started again.

While the modules have been described as acting in unison that is for illustrative purposes only. In some embodiments the modules may operate independently of one another. In some embodiments, fewer than all of the modules may be used. In some embodiments the first and second webs 22, 24 are the product of multiple sublayers. For example the second web may comprise both a PE layer and an insulating layer. Layers or sublayers may be quilted together, or attached in other ways. In some embodiments an insulating layer is attached to the second web 24 prior to attachment of the first web 22.

In some embodiments, the first and second webs 22, 24 are of different widths as those shown in figures. In some embodiment the second web 24 is not a single sheet but rather made of three, or a different number, separate sheets moving parallel to one another. In some such embodiments the sheets may move at different speeds relative to each other. The webs 22, 24 may have any number of thicknesses. In some embodiments, the thickness of each web is between 1 and 3 mm.

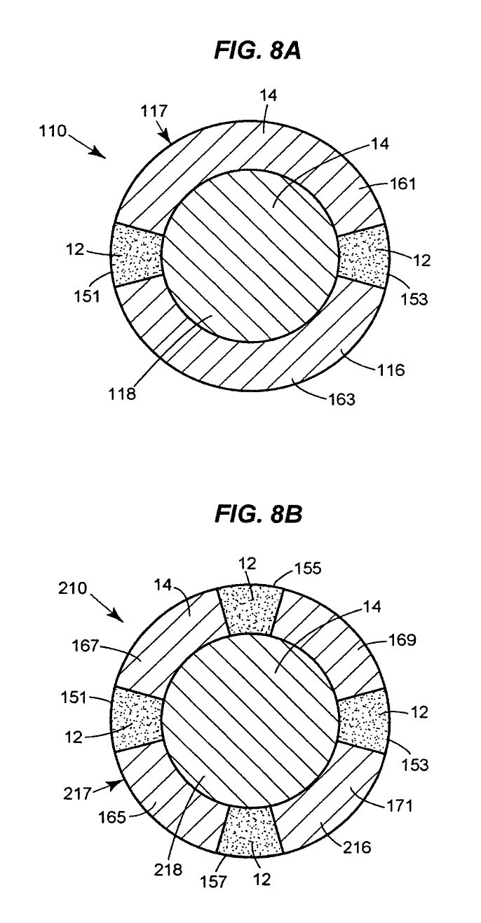

FIG. 8a shows another container cover 110 that can be manufactured according to the methods of the disclosure. The cover 110 is composed of first and second polymers 12, 14, and first and second layers 116, 118. The first and second polymers, 12, 14, may comprise those materials, and others, described above in respect to cover 10, e.g. polymer 12 may comprise an elastic material, e.g. an elastic film. The first layer 116 comprises four regions. A first region 151 and second region 153 may comprise the first polymer 12, whereas the third region 161 and the fourth region 163 may comprise the second polymer 14. The first and second regions 151, 153 may be diametrically opposed to each other, and the third region 161 and fourth region 163 may be diametrically opposed to each other. The second layer 118 may comprise the second polymer 14. The first layer 116 is operatively associated with the second layer 118, said layers being sealed about a perimeter 117.

FIG. 8b shows yet another container cover 210 that can be manufactured according to the methods of the disclosure, and which is a variation on the cover 110. The cover 210 is composed of first and second polymers 12, 14, and first and second layers 216, 218. The first layer 216 comprises eight regions. A first region 151, second region 153, third region 155 and fourth region 157 may comprise the first polymer 12, whereas the fifth region 165, sixth region 167, seventh region 169 and the eighth region 171 may comprise the second polymer 14. The first region 151 and second region 153 may be diametrically opposed, as may the third region 155 and fourth region 157. The second layer 218 may comprise the second polymer 14. The fifth region 165 and sixth region 167 may be diametrically opposed to one another, as may the seventh region 169 and eighth region 171. The first layer 216 is operatively associated with the second layer 218, said layers being sealed about a perimeter 217. As discussed in relation to cover 10, the covers 110 and 210 may be produced in any shape or size, and those depicted in the figures are for illustrative purpose only.

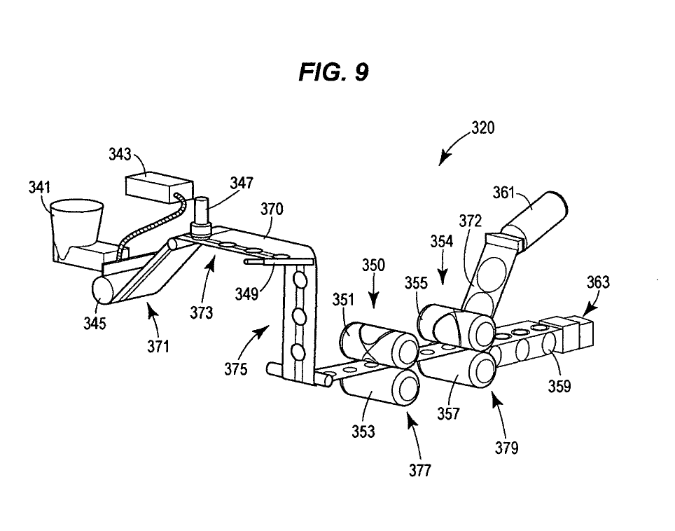

The apparatus 320, shown in FIG. 9, may be used to manufacture the container covers, e.g. 10, 110, 210 and other container covers. As depicted, the apparatus 320 is set up to manufacture the lid 110. The apparatus 320 comprises a first extruder 341 that may extrude a first polymer 12 and a second extruder 343 that may extrude a second polymer 14. The extruders 341 and 343 are operatively associated so that they may coextrude a multipolymer web 370 that may comprise both a first polymer 12 and second polymer 14. There is no limit to the number of polymers that may be comprised by the multipolymer web 370. The apparatus 320 also comprises a stamping device 347, a folding device 349 (e.g. a folding board), a sealing device 350, a cutting device 354, a conveying device 359, a reclamation system 361, and a stacking device 363. The sealing device may comprise a first heat sealer roll 351 and a second heat sealer roll 353. The cutting device may comprise a first die cutter roll 355 and a second die cutter roll 359. The stacking device 363 may comprise a stacking tray.

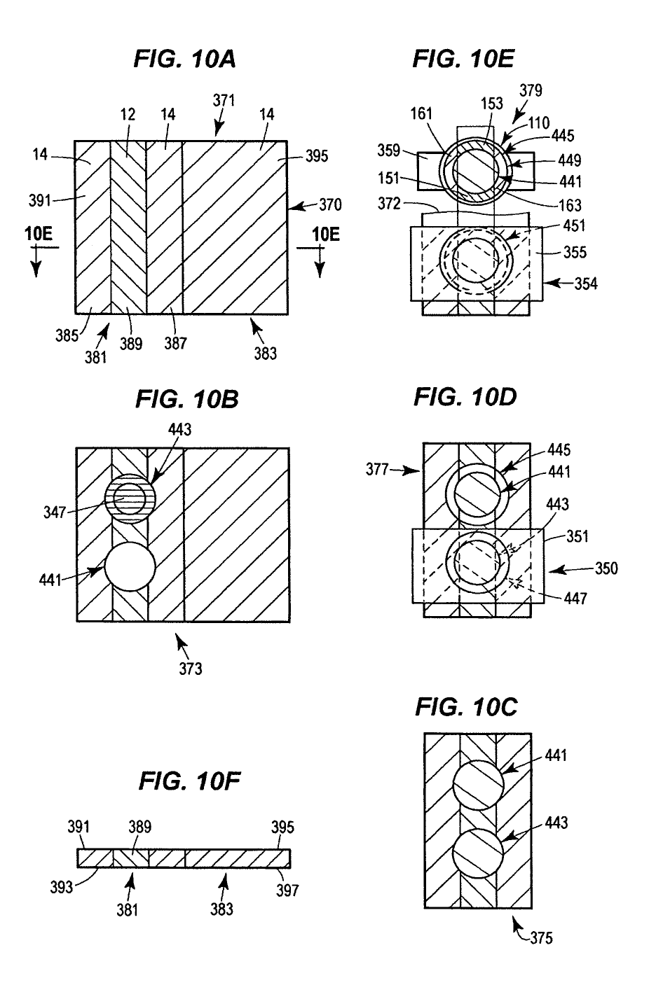

FIGS. 10a-10e show stages, 371, 373, 375, 377 and 379, of processing of the web 370 as it moves through the apparatus 320 as indicated in FIG. 9. As shown in FIG. 10a, in a first stage 371, the web 370 has just emerged from the extruders 341, 343. The web comprises a first portion 381 and a second portion 383. The first portion 381 comprises both first polymer 12 and second polymer 14. The first portion 381 comprises a stripe 389 flanked by two flanking regions 385, 387. The stripe 389 may comprise the first polymer 12, and the flanking regions 385, 387 may comprise the second polymer. The second portion 383 may comprise the second polymer 14. Additional features of the web 370 are illustrated in FIG. 10e, which shows a cross-sectional view of the web 370 depicted in FIG. 10a. The first portion 381 has a first surface 391 and a second surface 393. The second portion has a first surface 395 and a second surface 397. The first portion 381 may be substantially equal is size to the second portion 383.

FIG. 10b illustrates the second stage 373. The stamping device 347 has already cut out a first hole 441, and the stamping device 347 is shown in the process of stamping out a second hole 443. The holes, e.g. 441, 443, may be stamped out so that the stamp is centered on the stripe 389 and overlaps with the flanking regions 385, 387 as illustrated. However, this is for illustrative purposes only. For example, the stamping device 347 can be sized and/or the stripe 389 sized so that the hole 441 does not overlap the flanking regions 385, 387, but is rather contained by the stripe 389. Such an arrangement allows for the production of the container cover 10 shown in FIGS. 1a and 1b. In FIG. 10b, the first hole 441, having already been formed, is shown distal from the extruders 341, 343, relative to the second hole 443.

FIG. 10c shows the web 370 during a third stage 375, after it has been folded by the folding device 349. During folding, the first portion 381 and second portion 383 may be folded together so that the first surface 391 of the first portion 381 may be brought closer and/or in contact with the first surface 395 of the second portion 383. In the alternative, the second surface 393 of the first portion 381 may be brought closer and/or in contact with the second surface 397 of the second portion 383.

FIG. 10d shows the web 370 as it travels through a fourth stage 377. The first and second portions 381, 383 have already been sealed about a perimeter 445 surrounding the first hole 441. The first and second portions are shown in the process of being sealed together by the sealing device 350 about a perimeter 447 surrounding the second hole 443. While the holes 441, 443 are shown facing toward the first roller 351 and away from the second roller 353 that is for illustrative purposes only. The opposite orientation is also possible depending on how the web 370 is positioned in the apparatus 320, and how the web 370 is folded.

FIG. 10e shows a fifth stage 379. The cutting device 354 cuts the web 370 about a perimeter 451 surrounding the perimeter 447 and the second hole 443. The web 370 has already been cut about a perimeter 449 surrounding the perimeter 445 and the first hole 441 to form the container cover 110. The cover 110 rides on a conveying device 359 that will take it to a stacking device 363 that will ready the cover 110 for packaging. As described in respect to FIG. 10d, the orientation of the web 370, as well as the container cover 110, are for illustrative purposes only, and the opposite orientation is also possible. The now spent web 372, the residual product of the web 370, can be seen in FIG. 9. The spent web may be taken to a reclamation device 361, recycled and reused.

Container covers 10, 110, 210 and others may be alternatively assembled using a turntable. The first layers, e.g. 116, 216, are assembled from components corresponding to the regions, e.g. 151, 153, 161, 163 in the case of cover 110, and 151, 153, 155, 157, 165, 167, 169, and 171. The regions are sealed together. The assembled first layer, e.g. 16, 116, 116 is then attached to the second layer, e.g. 18, 118, 218 about a perimeter, e.g. 17 117, 217. In some embodiment the second layer, e.g. 18, 118, 218, rests on the turntable and the regions are attached the second layer directly.

The foregoing description of container covers, methods of manufacturing container covers and machines for manufacturing container covers have been set forth merely to illustrate the disclosure and are not intended to be limiting. Because modifications of the disclosed embodiments incorporating the spirit and substance of the disclosure may occur to persons skilled in the art, the disclosure should be construed to include everything within the scope of the claims to be presented and equivalents thereof.

What is claimed is:

1. A method of manufacturing a disposable container cover with an elastic perimeter, comprising the steps of:
extruding a first polymer web;
extruding a second polymer web onto the first polymer web, the first and second polymer webs forming a multipolymer web;
cutting a first shape through the multipolymer web;
folding the multipolymer web onto itself to cover the first shape;
sealing the folded multipolymer web, the seal having a second shape; and
cutting the sealed multipolymer web, the cut having a third shape.

2. The method of claim 1, wherein the first cutting step is performed by a stamping press.

3. The method of claim 1, wherein the second cutting roll is performed using at least one die cutter roll.

4. The method of claim 1, wherein the folding step is performed by a folding board.

5. The method of claim 1, wherein the first polymer is extruded onto a first longitudinal half of the second polymer, and the folding step folds a second longitudinal half of the second polymer over the first longitudinal half.

6. The method of claim 1, wherein the sealing step is performed using heat.

7. The method of claim 6, wherein the sealing step is performed using heater rollers.

8. The method of claim 1, wherein the first cutting step cuts entirely through the first polymer web, separating the first polymer web into multiple sections.

9. The method of claim 1, wherein the first polymer is more elastic than the second polymer web.

10. The method of claim 1, wherein the second polymer web is one of polyethylene or polypropylene.

11. The method of claim 1, further including the step of extruding a third polymer web onto the second polymer web, the third polymer web being more thermally insulative than the second polymer web.

12. A method of manufacturing a disposable container cover with an elastic perimeter, comprising the steps of:
providing a first polymer web above a second polymer web, the first polymer web being more elastic than the second polymer web;
cutting a first shape through the first polymer web;
sealing the first shape of the first polymer web to the second polymer web, the seal having a second shape; and
cutting the first and second web materials in a third shape.

13. The method of claim 12, further including the step of forming a pilot hole in the first polymer web prior to the first cutting step.

14. The method of claim 12, wherein the first shape is annular.

15. The method of claim 12, wherein multiple cutting steps are performed simultaneously.

16. The method of claim 12, wherein the first polymer web and the second polymer web are positioned parallel to each other.

17. The method of claim 12, wherein the first polymer web and the second polymer web are positioned perpendicular to each other.

18. The method of claim 12, wherein the first polymer web and the second polymer web are positioned transverse to each other.

19. The method of claim 12, further including the steps of simultaneously automatically advancing the first polymer web and the second polymer web.

20. The method of claim 12, wherein the cutting is performed by a stamping press.

21. The method of claim 12, wherein the sealing is performed using heat.

22. An apparatus for manufacturing a disposable container cover with an elastic perimeter, comprising:
a first extruder extruding a first polymer web;
a second extruder extruding a second polymer web, the first and second extruders positioned so as to form a multipolymer web with a ribbon of the first polymer web formed on the second polymer web;
a stamping press positioned over the multipolymer web to cut apertures in the multipolymer web;
a folder downstream of the stamping press;
first and second heated rollers downstream of the folder; and
first and second die rollers downstream of the heated rollers.

23. The apparatus of claim 22, further including a reclamation mechanism gathering waste portions of the multipolymer web.

24. The apparatus of claim 22, further including a stacking mechanism downstream of the first and second die rollers.

25. The apparatus of claim 22, wherein the folder is an angled folding roller.
